(19) United States
(12) Patent Application Publication
(10) Pub. No.: US 2024/0119388 A1
(43) Pub. Date: Apr. 11, 2024

(54) DIGITAL SYSTEM FOR FORECASTING A FUTURE DAMAGE OR LOSS IMPACT ON CARGO OR CARGO LOGISTICS SERVICES AND AUTOMATED ALLOCATING OF A DAMAGE COVER AND METHOD THEREOF

(71) Applicant: Swiss Reinsurance Company Ltd., Zürich (CH)

(72) Inventors: Sergio VACCANI, Zürich (CH); Andrea TANZI, Zürich (CH)

(73) Assignee: Swiss Reinsurance Company Ltd., Zürich (CH)

(21) Appl. No.: 18/543,686

(22) Filed: Dec. 18, 2023

Related U.S. Application Data
(63) Continuation of application No. PCT/EP2023/057825, filed on Mar. 27, 2023.

(30) Foreign Application Priority Data
Mar. 25, 2022 (CH) 000334/2022

(51) Int. Cl. G06Q 10/0635; G06Q 10/0833; G07C 5/00

(52) U.S. Cl. CPC G06Q 10/0635; G06Q 10/0833; G07C 5/008

(57) ABSTRACT

Proposed is a digital system and a method for forecasting and/or allocating risk measures for an occurrence of an impact event causing a physical loss or damage impact on cargo and/or cargo logistics causing a negative impact on the cargo and/or the cargo logistics services. Sets of measurable cargo logistics parameters are captured by the system as logistics input signals from a cargo logistics services database and are transmitted to an allocation structure. Each set of measurable cargo logistics parameters at least comprises cargo parameters and/or logistics parameters. At least one risk factor indicating a measured negative impact risk for the cargo and/or the cargo logistics services is captured by the system as risk input signals. Each of the risk factors at least corresponds to a measured impact strength or impact type of a negative impact on the cargo and/or the cargo logistics services, and/or a quantified damage at the cargo and/or on the cargo logistics services. At least one measurable cargo logistics parameter is assigned a risk factor by the allocation structure that corresponds to a measured value of the measurable cargo logistics parameters. An aggregated risk measure for the cargo logistics services is automatically generated by an aggregating structure of the processing unit based on the at least one risk factors allocated to measurable cargo logistics parameters and is provided as output signal by a signal generator to predict an occurrence of a measurable negative impact.

### CROSS REFERENCE TO RELATED APPLICATIONS

The present application is a continuation application of International Patent Application No. PCT/EP2023/057825, filed Mar. 27, 2023, which is based upon and claims the benefits of priority to Swiss Application No. 000334/2022, filed Mar. 25, 2022. The entire contents of all of the above applications are incorporated herein by reference.

### FIELD OF THE INVENTION

The present invention relates to methods and systems for forecasting and/or allocating and/or measuring risk measures associated with cargo logistics causing a potential damage to cargo handled by the cargo logistics. Cargo denotes goods, carriage/load of goods or freight to be transported, where cargo logistics denotes the flow or transportation of goods between the point of origin and the point of target or destination typically allocated with specific transportation requirements and conditions as time, type of transportation and/or type of transition. The resources or goods transported or handled in logistics, i.e. logistic process, may include tangible goods such as materials, equipment, and supplies, as well as food and other consumable items. In particular, the present invention relates to digital automated systems and methods for measuring and/or predicting risk measures for an occurrence of an event impacting on cargo logistics and cargo logistics services causing a negative, physical and measurable impact, i.e. damage or loss, on the cargo and/or the cargo logistics services. In particular, it relates to digital systems measuring and/or generating risk measures for automated cargo loss coverage or risk-mitigation systems.

### BACKGROUND OF THE INVENTION

Cargo logistics and/or cargo transportation provide an interface between cargo owners, cargo carrier entities and regulatory bodies. They are the backbone of a functioning global supply chain and as such provide a variety of different services. For example, cargo logistics include transportation for pickup of cargo from a cargo owner, cargo sorting, labelling, packing, palletization, customs clearance, selecting the most suitable transportation means and channel, booking of space with a cargo carrier, loading cargo onto the transportation means, providing updates about the shipment status at regular intervals, and arranging a destination delivery process which may include customs clearance and other formalities. Every type of cargo, every transportation means, channel and route, and every country have their own unique set of issues in the process of the cargo logistics services. Besides technical and infrastructural deficiencies for example related to transportation means, road, rail and port networks or seasonal weather implications, there are cargo specific complications like fragile products or hazardous materials. There are administrative and legal complications like non-compliance with work processes or regulations, strikes, regulatory bottlenecks, embargos, health lockdowns, etc. Natural catastrophes, like floods, strong winds, earthquakes or fires, may have a significant impact on all aspects of cargo logistics services. These deficiencies and incidences may result in diverse damages to the cargo or to the cargo logistics services resulting in cargo delay, damaging or loss.

Examples for incidents causing damage to the cargo or the cargo logistics services are:
Total loss of cargo—may happen either due to physical cargo damaging by an impact event or theft while in custody of the cargo logistics services provider and freight forwarder, respectively, and cargo carrier.
Damaging of cargo—may happen either due to incorrect or improper packaging of the cargo, incorrect or improper handling of the cargo while in the custody of the cargo logistics services provider and cargo carrier.
Rerouting of cargo—may happen if documentation submitted to the cargo carrier by the cargo logistics services provider was incorrect and cargo ended up at another destination.
Delays of cargo—may happen either due to weather impacts, political disruptions or administrative failures for example due to improper documentation like receipt of cargo at the destination was delayed due to incorrect cargo declarations filed with customs or any other types of cargo documentation required for the transportation.

Cargo owners rely on the cargo logistics services provider and will hold them liable for picking up the cargo, arranging for proper packaging, handling all the documentation, clearances en-route and delivering it to the receiver at the final destination, at the right price and in the same condition that it is picked up from origin using the most suitable transportation mode and routes possible.

Therefore, a cargo logistics services provider needs to have or be sufficiently insured for example with full liability protection to cover all forwarding operations, third party liabilities, regulatory breaches, errors & omissions and legal liability (all providers may be exposed to contractual liability for a loss, irrespective of who is responsible), survey and mitigation costs, recovery and remediation costs, and salvage charges including cargo disposal. In summary a comprehensive risk management and liability coverage is needed that is appropriate for a defined cargo logistics services package and that allows for competitive pricing of the package. Therefore, insurance policy underwriters of various insurance providers are briefed on the terms and conditions of the cargo logistics services package so that they can customize insurance policy and premiums. As a result, there are many risk cover packages and various insurance providers, which results in tedious processes to receive and compare different packages and decide for the best cover and best pricing.

This is addressed in the state of the art as known for example from US 2002/0169710 A1. A system for negotiating logistics and risk-transfer transactions includes interfaces for connecting logistics providers, insurance providers, and e-marketplaces. An agent software module is configured to search the internet for pricing information that is used to maintain a current database of pricing and terms. The e-marketplaces allow purchasers to enter descriptions of items to be shipped and insured. The system may then search the current database to provide the purchaser with a quote for freight and insurance services.

A system providing a metric structure for various objects, including transportation systems is shown in WO 2011/079324 A2. In particular, the metric structure may be used for a broad range of applications, such as assessing and controlling insurance risk, determining insurance premiums, prioritizing tasks, travel, navigation, advertising, and other purposes.

A transportation insurance system is disclosed in CN106448215A, where upon detecting a vehicle insurance claim, the current location of the vehicle is assessed for car insurance service. Further, a transport line and intersections within a preset distance from the current position is determined, and information about the vehicle insurance claiming events is captured which are related to the transport line and the intersections and occurrence within a preset time in the past. Based on the information, the compensation pay-out is generated due to traffic accidents on each road section of the transport line.

CN113298663A discloses a dynamic pricing system for a logistics transportation platform. The system performs the steps of (i) achieving the pricing of a basic price of a future insurance premium through a convex combination average method and an expectation function method based on the historical loss data of a logistics transportation platform; (ii) establishing a reward and punishment system: classifying target objects by utilizing a clustering algorithm, and further realizing pricing of future insurance premium based on differentiated prices of the target objects; and (iii), determining a price adjustment period, and repeating the step (i) and the step (ii) so as to achieve dynamic adjustment of the future insurance premium price.

The document US 2021/0082220 A1 shows a system for monitoring and managing loading docks and facility operations. The system comprises a data analyzer to monitor first data indicating whether a truck trailer is present at a dock of the material handling facility, and to monitor second data indicating a condition associated with a door at the dock. The second data are different than the first data. A notification generator generates a notification based on the first data and the second data. In this context, loading docks provide an area for vehicles (e.g., trucks, trailers, etc.) to move next to an elevated platform of a building (e.g., a material handling facility) so that cargo can be readily transferred between the vehicle and the building. Some loading docks include equipment such as dock levelers, vehicle restraints, and/or dock doors, any of which can be associated with one or more sensor/monitoring systems. Within material handling facilities there can be additional equipment to facilitate the movement, storage, and/or handling of cargo such as, for example, grade-level doors, HVAC (heating, ventilation, and air conditioning) systems, industrial doors to partition freezer rooms and/or other rooms, conveyor systems, fans for air movement within the facility, lighting, and signal systems, etc. Further, US 2005/0171870 A1 discloses a distribution management system applicable for the delivery of ordered cargo to a destination. The system comprises with a database server. The internal processing section of the database server comprises a shipping instruction processing section for instructing the delivery of the ordered cargo to the destination including a physical distribution trader, a physical distribution expense calculation processing section for calculating physical distribution expenses necessary for the delivery of the cargo to the destination, and a cargo tracking processing section for indicating the delivery status of the cargo. The distribution management system automatically manages the cargo so that all of shipping instruction concerning the cargo can be transmitted to the physical distribution trader simply by accessing a portal site. Finally, CN106448215A discloses an automated vehicle insurance claim warning system. When detecting a vehicle insurance claiming warning instruction, the system gets the current location of a vehicle for car insurance service and gets a transport line and intersections within a preset distance from the current position and gets information about vehicle insurance claim events which are related to the transport line and the intersections and happened within a preset time in the past. The system calculates the compensation pay-out generated due to traffic accidents on each road section of the transport line and at each intersection according to the vehicle insurance claiming event information and takes the road sections of the transport line and/or the intersections, which meet the condition that the compensation pay-out generated due to traffic accidents is greater than a preset amount of money, as risk areas. The system outputs warning information corresponding to the risk areas.

In summary, the prior art concepts focus on individual aspects of transportation logistics, price development and risk controlling. However, the known concepts cannot provide a holistic procurement of cargo logistics services considering related risks and including optimized insurance risk processing.

### SUMMARY OF THE INVENTION

It is one object of the present invention to provide a digital system and method for forecasting, allocating and/or measuring risk measures for cargo logistics being affected by a potential damage to cargo handled by the cargo logistics process that allow for transparency around cargo shipping, automated access to comprehensive and reliable cargo loss and/or damage coverage, transparent booking and quoting processes for cargo logistics services and simple and convenient interaction with logistics services providers and insurance providers. In particular, it is an object of the present invention to provide digital methods and systems for allocating and/or predicting risk measures for an occurrence of an impact event on cargo logistics services that provide automation for risk analysis and/or measurement of cargo liability risks related to cargo logistics services, allow for standardized risk coverage and rapid digital end-to-end risk management. In particular, it is an object of the present invention to provide digital methods and systems measuring and/or generating risk measures for logistics procurement platforms and cargo insurance systems.

According to the present invention, these objects are achieved particularly through the features of the independent claims. In addition, further advantageous embodiments follow from the dependent claims and the description.

According to the present invention, the above-mentioned objects are particularly achieved by the inventive digital system and method for a digital system for predicting and measuring risk measures for an occurrence of an impact event impacting physical loss or damage on cargo or cargo logistics services having an impact with a measurable impact strength related to an impact type on the cargo or the cargo logistics services, the impact strength being quantified by measuring an impact severity or intensity and an impact duration and/or an impact frequency, in that sets of measurable cargo logistics parameters are captured by the system as logistics input signals from a cargo logistics services database via a data interface and transmitted to an allocation structure of a processing unit, each set of measurable cargo logistics parameters at least comprising parameters defining the cargo or parameters or defining the logistics services, the set of measurable cargo logistics parameters at least comprises cargo parameter values capturing cargo characteristics including cargo weight and/or cargo size and/or cargo fragility and/or cargo value, and logistics parameter values capturing logistics characteristics including cargo packaging design and/or departure location characteristics and/or destination location characteristics and/or transportation channel characteristics and/or transportation means, wherein the cargo and logistics parameters are at least partially detected and transmitted by tracking devices comprising RFID chips or telematic devices or GPS sensors installed at the cargo, the tracking devices measuring parameter values for geo location of the cargo, the orientation of the cargo or the velocity of the cargo and transmitting them via a data transmission network to the cargo logistics services database, in that at least one risk factor indicating a measured impact probability for the cargo or the cargo logistics services is generated by a risk modelling structure of the processing unit based on at least the measured parameter values of the impact strength and/or impact types and/or measured quantified damages and provided for the allocation structure of the processing unit, each of the risk factors at least corresponds to a measured impact strength or impact type of a negative impact on the cargo or the cargo logistics services, or a quantified damage at the cargo or on the cargo logistics services resulting from the impact, in that at least one measurable cargo logistics parameter of a set of measurable cargo logistics parameters is assigned a risk factor by the allocation structure that corresponds to a measured value of the measurable cargo logistics parameters, and in that an aggregated risk measure for the cargo or cargo logistics services is automatically generated by an aggregating structure of the processing unit based on the at least one risk factors allocated to measurable cargo logistics parameters of the set of measurable cargo logistics parameters, and is provided as output signal by a signal generator to predict an occurrence of a measurable negative impact on the cargo and/or the cargo logistics services.

In summary, the digital system for providing risk measures for an occurrence of a harmful impact event on cargo logistics services handling the cargo and/or on the cargo itself according to the invention for implementing the above described method is designed to receive the set of measurable cargo logistics parameters from the cargo logistics services database, find at least one risk factor quantifying the risk of occurrence of such an impact event related to the measurable cargo logistics parameters, and generating a combined risk measure to predict the probability and preferably also the severity of the occurrence of the impact event.

The measurable cargo logistics parameters are captured by the cargo logistics database for example when a cargo owner and a provider of cargo logistics services define the cargo that has to be shipped and define the details of the shipping mode, i.e., the cargo logistics services. The measurable cargo logistics parameters can be any type of measurable value or technical characteristics of a cargo to be shipped or defining a service aspect of the logistics services to ship the cargo. As such the measurable values or technical characteristics can be captured by physical measurands and they define the cargo characteristics and/or the logistics characteristics. In one variant of the method the set of measurable cargo logistics parameters at least comprises cargo parameter values capturing cargo characteristics for example including cargo weight, cargo size, cargo fragility and/or cargo value, and/or logistics characteristics for example including cargo packaging design, departure location characteristics, destination characteristics, transportation channel characteristics, and/or transportation means.

Particularly, cargo parameters capture the weight and size of the cargo for example measured by a cargo measuring device like a scale or a size detector, the material and manufacturing of the cargo may for example be identified by measuring sensors to determine fragility of the cargo or the packaging design protecting cargo from being damaged. Logistics characteristics my capture services parameters about the length of a cargo route, e.g., measured by using a geographic information system, parameters about departure locations and port of entry, and the performance of transportation means indicated for example in average speed or fuel consumption, etc. The cargo may for example be provided with an identification means like an RFID tag or telematic devices providing and transmitting measurable cargo logistics parameters of the cargo for simple read out by a reading device transmitting the measured parameters to the cargo logistics services database.

The method for allocating and/or predicting risk measures for an occurrence of an impact event on cargo logistics services causing a negative impact with a measurable impact on the cargo and/or the cargo logistics services in one example variant uses risk factors based on historical data for measurable cargo logistics parameters as mentioned above. Advantageously, the aggregated risk measure is determined based on such existing or past measures of risk parameter values for one or more cargo logistics parameters defining the cargo logistic services. Thus, the output signal is indicative of the aggregated risk measure for the cargo logistic services in respect to the set of measured values for the cargo logistics parameters. For example, in a basic variant of the method according to the invention, the allocation structure assigns a risk factor to a measurable cargo logistics parameter by: (1) receiving a measured cargo logistics services parameter defining the cargo logistics services or the cargo from the cargo logistics services database via the logistics input signal, (2) selecting at least one risk factor provided by the risk factor database via the risk input signal for an at least similar cargo logistics parameter indicating a damage probability measure based on past measured damages caused by past measured impact events related to the value of the cargo logistics parameter, and (3) allocating the at least one risk factor to the measured cargo logistics services parameter defining the cargo logistics services.

In one variant of the method according to the invention at least one risk factor is based on measurable risk parameters indicating the negative impact or the type of impact on the cargo and/or the cargo logistics services caused by the impact by indicating a damage in form of a delay of the cargo, damaging of the cargo and/or loss of the cargo. In one example, at least one risk factor is based on measurable risk parameter values capturing a time of delay (e.g., compared to an estimated time of delivery), a quantified damaging extend and/or a loss of the cargo. A risk factor for an associated cargo logistics parameter can for example be established by measuring the physical impact strength or impact type of impact events on the cargo and/or the cargo logistics services affected by the impact event, measuring the impact strength on the cargo or the cargo logistics services, measuring a damage of the cargo and/or the cargo logistics services caused by the impact event, and/or quantifying a probability of impact occurrence.

The risk factors are for example based on measured data parameters of cargo logistics services or of cargo that had been impacted by a negative impact event in the past. For these past impact events the measured cargo logistics parameters and the corresponding damage to the cargo logistics services and/or the cargo are recorded as historical data. The historical data indicates the measured impact strength or impact type of a negative impact on the cargo and/or on the cargo logistics services, and/or a quantified damage at the cargo and/or on the cargo logistics services resulting from the negative impact. In particular, the historical data my indicate a strength of a storm, the temperature and location at the time of the impact, the delay time with respect to an estimated time of delivery on a specified transportation route, the type of impact for example in form of dropping the cargo by a specified cargo lifting device at a specified location, crushing the cargo in a specified cargo storage means, loss of the cargo on a specified route using a specified transportation means, theft or piracy on a specified transportation route at a specified location, delay time of processing cargo formalities in specified departure locations and at specified ports of entry, etc.

The historical data serves as the basis for statistical analysis to quantify the probability of a negative impact on cargo logistics services and/or on cargo that is defined by a measured cargo logistics parameter. The quantified probability is represented by the risk factor for the measurable cargo logistics parameter. In one variant of the system and the method according to the invention the processing unit and/or the risk factor database may include a damage or risk modelling structure, which generates the risk factor for a measurable cargo logistics parameter based on a measured impact strength or impact type and/or a measured quantified damage. The damage or risk modelling structure may use the historical data to assess the impact risk based on technical measurands. The risk factor database stores risk factors for a wide range of measurable cargo logistics parameters.

The allocation structure of the processing unit receives the set of measurable cargo logistics parameters defining selected logistics services for a specified cargo. Further, the allocation structure captures at least one risk factors, preferably a set of risk factors, from the risk factor database, which risk factors correspond to these cargo logistics parameters and the measured value of the cargo logistics parameter. Preferably, the allocation structure assigns a risk factor to each of the parameters of the set of measurable cargo logistics parameters. Ideally, the measured cargo logistics parameter that served as the basis to determine an associated risk factor is equal to the cargo logistics parameter defining the cargo logistics services to which the risk factor is assigned. However, small deviations between the historical cargo logistics parameters serving as basis for determining the risk factor and the cargo logistics parameters defining the present cargo or cargo logistics services can be neglected, particularly if they are statistically insignificant. Significant deviations can be taken into account by adjusting the risk factor, for example by including an uncertainty factor or weighing factor. For example, the damage or risk modelling structure may determine the uncertainty factor based on regression analysis.

The at least one risk factor or the set of risk factors assigned to the cargo logistics services is captured by the aggregating structure of the processing unit, which automatically generates the aggregated risk measure for the cargo logistics services to predict an occurrence of a measurable negative impact on the cargo and/or the cargo logistics services. The aggregated risk measure is provided as the output signal by a signal generator.

The digital system serves as a forecasting module or device to indicate the likelihood of a negative impact on the defined cargo or cargo logistics services in questions. The aggregated risk may be used for example for decision making about cargo processing, services pricing or insurance coverage. The system and method providing the aggregated risk measure support transparent and reliable risk management for the cargo to be shipped, insurance policies can be drafted in real-time providing fast and convenient interaction with insurance providers. Comparison between different cargo logistics services packages, each defined by a different set of measurable cargo logistics parameters, is made quick and easy, which helps optimizing cargo logistics services.

In one variant of the method according to the present invention, the aggregated risk measure is assigned to the set of measurable cargo logistics parameters by the allocation structure and provided as extended output signal to the cargo logistics services database by the signal generator via a data interface. The aggregated risk measure itself is part of the set of measurable cargo logistics parameters in real time and may serve as the basis for quoting, booking, pricing and scheduling the cargo logistics services.

In summary, the aggregated risk measure is generated by the aggregating structure and can be allocated to the set of measurable cargo logistics parameters, the aggregated risk measure providing an aggregated impact probability measure value for the cargo logistics services to be involved in one or more impact events having a negative impact with a measurable impact strength.

In one example variant the cargo logistics services are managed by a digital logistics procurement platform comprising the cargo logistics services database with the cargo logistics services parameters for providing online services for cargo owners and cargo logistics providers. The logistics procurement platform for example allows for coordinating service availabilities, scheduling services, collecting customer data, providing information, drafting service quotes, tracking of the cargo, etc. The digital system can be implemented as a forecasting module into the digital logistics procurement platform. For example, the system can be a plug-in or add-on module that is implemented to the logistics procurement platform by a plug-in interface. With the forecasting module the platform can serve as an end-to-end logistics services procurement tool with fully integrated insurance value proposition, which simplifies the customer journey to a one-stop-shop that addresses all customer needs of a cargo owner. The cargo logistics services provider profits from real-time insurance propositions for his cargo logistics services to be included in his quoting and booking offers.

In a simple version of the system and the method according to the invention an aggregated loss risk measure indicating a loss of the cargo by the cargo logistics services is generated based on the risk factors associated to the measured cargo logistics services parameter by the aggregating structure. The aggregated loss risk measure may be automatically generated by aggregating structure based on a subset of risk factors for measurable cargo logistics parameters that predict the complete loss of the cargo while processed by services of a cargo logistics services package defined by a set of measurable cargo logistics parameters. The aggregated loss risk measure may be provided in addition to the aggregated risk measure as additional risk assessment.

In a still further variant of the system and the method according to the invention at least one risk factor is based on measurable risk parameters indicating a damage in form of damaging of goods other than the cargo being shipped by the cargo logistics services. Such goods are for example other cargo units for example shipped by the same cargo logistics service, e.g., the cargo handling or transportation means shipping the cargo, or such goods are property at the departure or destination location or in-between. Such goods can also be represented by general common goods like air, water, or land. These goods may be damaged by emissions caused by the cargo logistics services or by exploitation for providing the cargo logistics services. The risk parameters may for example be based on measurement values of carbon dioxide emissions caused by the transportation means or environmental impact measures indicating exploitation of land or sea.

In a still further variant of the system and method for allocating and/or predicting risk measures for an occurrence of an impact event on cargo logistics services causing a negative impact according to the invention the processing unit may comprise an optimization structure for optimizing the set of measurable cargo logistics parameters for a cargo logistics service to minimize the probability of the occurrence of an impact event on the cargo logistic service indicated by the aggregated risk measure. For example, the optimization structure comprises an optimization algorithm based on combinatorial optimization to find the combination of cargo logistics services parameters with the lowest aggregated risk measure. For example, the optimization structure receives cargo logistics services characteristics from the logistics input signal and a set of risk factors for one or more of the cargo logistics services characteristics from the risk factor database. The optimization structure selects the cargo logistics parameter comprising the lowest risk factor for each cargo logistics services characteristic and combines the lowest risk cargo logistics parameters to define the set of measurable cargo logistics parameters determining the cargo logistics services package. The lowest risk factor is for example defined by the lowest physical impact strength of impact events on the cargo and/or the cargo logistics services affected by the impact event, a lowest impact strength on the cargo or the cargo logistics services, a lowest damage of the cargo and/or the cargo logistics services caused by the impact event, and/or a lowest probability of impact occurrence. For example, the cargo owner intends to deliver a fragile cargo item from a departure point to a destination in a given maximum time period. The optimization structure can be configured to evaluate and indicate the transportation means and transportation route and the packaging design for this transportation mode such, that the set of cargo logistics services parameters comprises the lowest possible aggregated risk measure.

In an even further variant of the system and method according to the invention the aggregation structure and/or the optimization structure may be combined with an appropriate artificial intelligence structure comprising a machine learning algorithm. For example, a supervised algorithm may be used to group risk factors of the cargo logistics services parameters to determine a minimized aggregated risk measure. Also, a transfer learning algorithm may be used to improve the aggregation of risk factors or optimize the selection of cargo logistics services parameters for a given service package.

The digital system and method for allocating and/or predicting risk measures for an occurrence of an impact event on cargo logistics services causing a negative impact on the cargo and/or the cargo logistics services according to the invention provides simple and fast access to a reliable and quantified risk assessment for cargo owners and logistics providers. The aggregated risk measure provides the foundation for insurance services at all levels. The digital system can be implemented in existing logistics platforms for easy access to logistics providers. It allows for seamless and integrated risk assessment and insurance solutions at the point of sale of logistics services. The cargo logistics services are summarized by the output signal, which includes the set of logistics parameters defining the logistics services package and the aggregated risk measure defining insurance options for the package. Such insurance orchestration ensures price competition without complexity of choice for the cargo owner or services provider. Therefore, the cargo owner has significantly lower effort and costs to fulfil contractual obligations towards cargo recipients. The logistics services providers offer excellent logistics services including insurance costs provision. The logistics services are improved with respect to minimized risks and cargo damage, timelines and quality. The lower service effort to provide insurance options frees up capacity for client servicing. The systematic insurance provision generates additional resource availability and allows for efficient policy issuance and claims management.

### BRIEF DESCRIPTION OF THE DRAWINGS

The present invention will be explained in more detail below relying on examples and with reference to these drawings in which:

FIG. 1 shows a first flow diagram of a first variant of a method for a digital system for allocating and/or predicting risk measures for an occurrence of an impact event on cargo logistics services causing a negative impact with a measurable impact on the cargo and/or the cargo logistics services according to the present invention.

FIG. 2 shows a block diagram illustrating an exemplary digital system for allocating and/or predicting risk measures for an occurrence of an impact event on cargo logistics services causing a negative impact with a measurable impact strength on the cargo and/or the cargo logistics services according to the present invention.

FIG. 3 shows a second flow diagram of a further variant of a method for a digital system for allocating and/or predicting risk measures for an occurrence of an impact event on cargo logistics services causing a negative impact with a measurable impact on the cargo and/or the cargo logistics services according to the present invention.

### DETAILED DESCRIPTION OF THE PREFERRED EMBODIMENTS

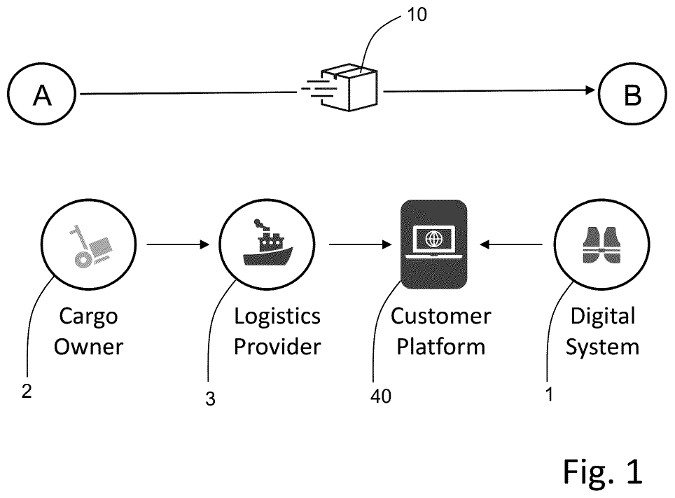

FIG. 1 schematically illustrate an architecture for a possible implementation of an embodiment of the inventive digital multi-channel platform 1 based on a multi-channel, high-layer data-transfer structure 1113 accessible by means of web-client applications 121 running on front-end network-enabled devices 12 providing discrete high-layer data-flow and capturing of structured 1121 and unstructured 1122 data content transferred from the front-end network-enabled devices 12 over a data transmission network 13 to a digital multi-channel back-end system 11.

FIG. 1 illustrates the underlying concept of a cargo logistics process and cargo flow by transporting and/or shipping cargo 10 from a departure point A to a destination point B. A cargo owner 2 places an inquiry for shipping the cargo from departure point A to destination point B with a logistics provider 3. The cargo owner 2 can be a manufacturing company producing the cargo goods, a warehouse distributing cargo goods, a private party or any other entity who wants to ship the cargo. The logistics provider 3 for example is a freight forwarder that manages all cargo logistics services required to safely transport the cargo 10 from departure point A to destination point B within a given timeframe. The logistic services of cargo shipping encompass the execution of all necessary activities involved in transporting the cargo, which ranges from cargo pick up at the departure point, packaging, transportation operations, keeping track of the cargo throughout its journey, delivery to the destination point, arranging cargo insurance, as well as services for logistics quoting, booking, scheduling, alerting, controlling and/or processing cargo formalities. The cargo logistics services can be defined by measurable cargo logistics parameters 11 as will be explained in more detail below.

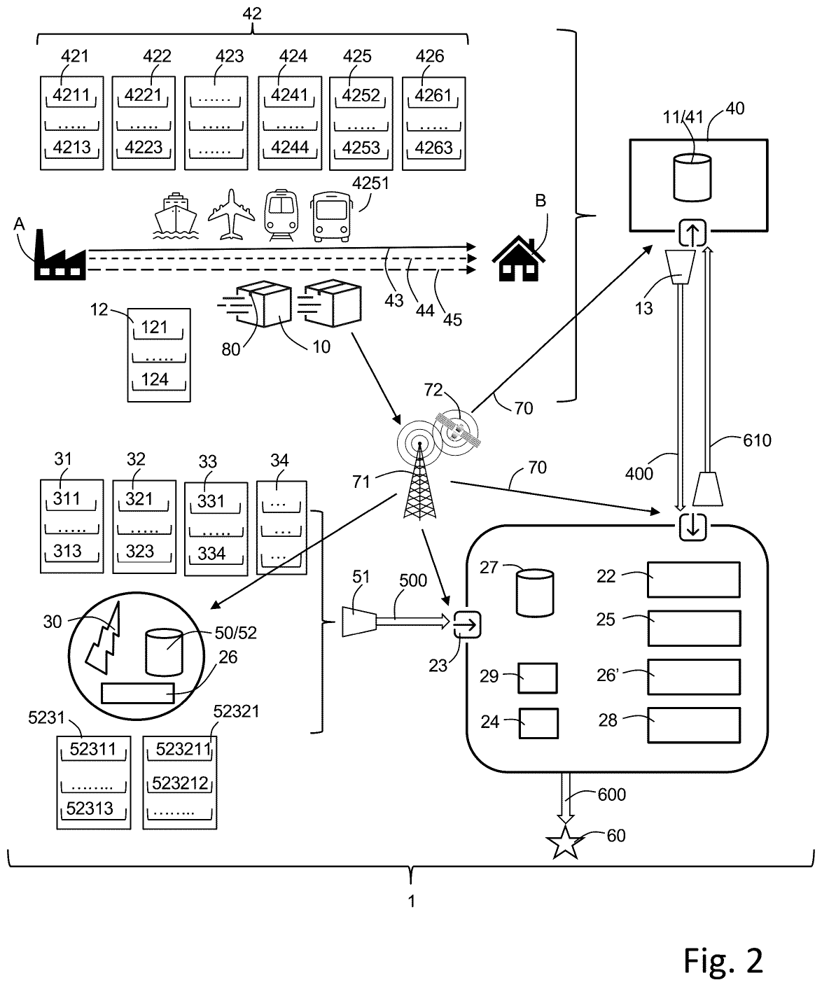

Most cargo logistics providers maintain a digital logistics procurement platform 40 or customer portal for managing information, documentation and data around the cargo logistics services for shipping the cargo 10 from A to B. The procurement platform 40 may be realized as a computer-based internet application or as a software network on site of the logistics provider 3 or any other digital application that allows for receiving, storing, processing and transmitting data. The procurement platform 40 may comprise or be connected to a cargo logistics services database 41 storing measurable cargo logistics parameters 11 of the logistics services offered or provided. As shown in FIG. 1, a digital system 1 is implemented or connected to the logistics procurement platform 40 for example using an application programming interface (API) architecture. The digital system 1 is designed as a digital system for allocating and/or predicting risk measures for an occurrence of an impact event on cargo logistics services causing a negative impact 30 on the cargo and/or the cargo logistics services according to the present invention. The digital system 1, which is explained in more detail in FIG. 2, provides aggregated risk measures 60 as a basis for risk management services like insurances for the cargo logistics services. Thus, the platform can represent a single point-of-sale for logistics and insurance services, as such the platform serves as a digital touchpoint for all services around cargo logistics.

FIG. 2 illustrates the digital system 1 and a method for the digital system 1 for allocating and/or predicting risk measures for the occurrence of an impact event on cargo logistics services causing the negative impact 30, which can be defined by a measurable impact strength 31 or an impact type 32 on the cargo 10 and/or on the cargo logistics services according to the invention. The digital system 1 comprises a processing unit 20 and at least one data interface 21 associated with data access means to the cargo logistics services database 41 for capturing sets 13 of measurable cargo logistics parameters 11 as logistics input signals 400 from the cargo logistics services database 41. The sets 13 of measurable cargo logistics parameters 11 are transmitted to an allocation structure 22 of the processing unit 20. Each set 13 of measurable cargo logistics parameters 11 at least comprises one or more cargo parameters 12 defining the cargo and/or one or more logistics parameters 42 defining the cargo logistics services.

The system 1 comprises at least one data interface 23 associated with data access means to a risk factor database 50 for capturing at least one risk factor 52, preferably a set of risk factors 51, indicating a quantified/measured negative impact risk for the cargo 10 and/or the cargo logistics services as risk input signals 500 from the risk factor database 50. The at least one risk factor 52 or the set of risk factors 51 are provided to the allocation structure 22 of the processing unit 20. Each of the risk factors 52 at least corresponds to the measured impact strength 31 or impact type 32 of a negative impact 30 on the cargo 10 and/or on the cargo logistics services, and/or to a quantified damage 33 at the cargo 10 and/or on the cargo logistics services resulting from the negative impact 30. At least one measurable cargo logistics parameter 11 of a set 13 of measurable cargo logistics parameters is assigned a risk factor 52 by the allocation structure 22 that corresponds to the measured value of the measurable cargo logistics parameters 11.

Further, the digital system 1 comprises a signal generator 24 and an aggregating structure 25 for automatically generating an aggregated risk measure 60 for the cargo logistics services based on the at least one risk factor 52 or the set of risk factors 51 allocated to measurable cargo logistics parameters 11 of the set 13 of measurable cargo logistics parameters 11. The aggregated risk measure 60 is provided as output signal 600 by the signal generator 24 to predict an occurrence of a measurable negative impact 30 on the cargo 10 and/or the cargo logistics services. Thus, the aggregated risk measure 60 represents a quantified risk value that can be used for decision making and insurance purposes.

The digital system 1 and the method of the invention provide an end-to-end cargo insurance system integratable into the logistics services procurement platform 4 allowing to provide a one-stop-shop for customers seeking logistics services procurement. The invention allows to provide a holistic logistics services portal covering all aspects needed to offer, book, schedule and manage logistics services, for example comprising (a) online service availability and scheduling, (b) instant digital quoting and booking for the logistics services including appropriate risk coverage, (c) simple and standardized all risks coverage, (d) immediate digital insurance certification and underwriting, and (e) fully automated, digital claims management. The digital system 1 may be provided to the logistics procurement platform 40 of the logistics service provider 3 for example via API services, allowing the logistics service provider to integrate and exploit the method according to the invention easily into its existing platform. At the same time an insurance provider receives all required information about the cargo logistics services to provide an insurance cover package and quoting thereof. Thus, the logistics service provider 3 may act as a digital distribution partner for the insurance provider and provide risk-transfer access for transportations to customers through its logistics services provider platform 40.

In one embodiment of the digital system 1 the cargo logistics services database 41 and/or the risk factor database 50 may comprise a persistent data storage storing data of the measurable cargo logistics services parameters 11 and/or the risk factors 52. The processing unit 20 may have a database 27 for at least temporarily storing parameter data or risk factors for processing and further transmission. Additionally or alternatively, the processing unit 20 can for example be connected via a data transmission network 70 or data transmission line, e.g., comprising a cellular mobile network 71 and/or a satellite transmission line 72 to the logistics procurement platform 40 and/or the risk factor database 50.

As illustrated in FIG. 2 the cargo 10 and the cargo logistics services are defined by cargo characteristics and logistics characteristics, which are determined by measurable parameter values of the cargo parameters 12 and the logistics parameters 42. For example, the cargo 10 intended to be shipped is defined by measured values for the cargo parameters 12 for example indicating parameter values capturing cargo weight 121, cargo size 122, cargo fragility 123 and/or cargo value 124. Of course, further cargo characteristics may be determined by further cargo parameter values. The cargo logistics services for shipping the cargo 10 are defined by measured logistics parameter values for example capturing cargo packaging design 421, departure location characteristics 422, destination characteristics 423, transportation channel characteristics 424, transportation means characteristics 425 and/or logistics formalities 426. Parameter values for the cargo packaging design 421 may for example capture packaging material 4211, packaging thickness 4212, packaging quality 4213, and other packaging parameter values. Parameter values for the departure location characteristics 422 may for example capture geographical location 4221, infrastructure connectivity 4222, traffic volumes 4223, crime density and further values. Destination location characteristics 423 may capture similar parameters as the departure location characteristics. The transportation channel characteristics 424 may capture cargo and logistics parameter values for example each of several alternative transportation routes. For example, the cargo could be transported via an air transportation route 43, a sea transportation route 44 or a land transportation route 45. The transportation channel characteristics 424 may capture for example a length of the route 4241, the number of transits 4242 on the route, expected weather conditions 4243, infrastructure conditions 4244, etc. Parameter values for the transportation means 425 may capture a transportation means type 4251 like ship, plane, train or truck, the fuel efficiency 4252 of the transportation means, the age 4253 of the transportation means, etc. Parameter values for the logistics formalities 426 may capture parameter values for a type of required regulatory process 4261, a number 4262 of required regulatory processes, average processing times 4261 of a regulatory process and further related parameter values.

The risk factors 52 indicating a quantified or measured negative impact risk for the cargo 10 and/or the cargo logistics services are derived from measured parameter values quantifying the characteristics of the impact like the impact strength 31 or the impact type 32 of a negative impact 30 on the cargo 10 and/or the cargo logistics services, and/or a quantified damage 33 at the cargo 10 and/or on the cargo logistics services resulting from the negative impact 30. The impact type 32 can for example be captured by classifying the negative impact 30 as a natural catastrophe 321 like a storm impact or flood impact, a labor disruption 322 like a strike or health emergency, an administrative or regulatory discontinuation 323 or other types of negative impacts. The parameter values representing an impact strength 31 relate to the impact type 32. However, the impact strength 31 may for example reliably be quantified and measured by capturing an impact severity or intensity 311 like a storm force or flood height, an impact duration 312 like an average duration of a strike at a cargo transit point, and an impact frequency 313 like an incidence of administrative discontinuations e.g., for over-booking of a transportation means or late arrival of transport documents. The quantified damage 33 caused by an impact event 30 is determined by parameter values for example indicating the damaging that the cargo suffers cargo from the impact 30 for example by measuring a downtime 331 of the cargo caused by the damaging or repair costs 332, and the damaging the cargo logistics services suffer from the impact 30 e.g., by measuring a delay time 333 or additional costs for rerouting 334. The cargo damaging may also be captured as loss of the cargo 34.

Parameter values for the impact strength 31, the impact type 32 and the quantified damage 33 may for example be received as geographical data, weather data, quality control data or other physically recorded data from existing technical measuring entities. Further, the quantified parameter values can be received as statistically determined physical data like average duration periods, average frequencies or average intensities. The data may for example be provided from known natural catastrophe evaluation services like a CatNet (Catastrophe Net) tool and/or other similar tools. For example, the CatNet tool (short for Catastrophe Network tool), provides an internet service offering users comprehensive information on natural hazards worldwide. CatNet enables users to gain a fast overview of natural perils by means of an electronic atlas. It provides easy access to up-to-date maps, showing the most relevant perils worldwide. The tool helps to evaluate the risks for any location on earth. CatNet is composed of an electronic atlas, country-specific insurance portfolio information and damage or loss event data. The tool can be used to provide parameter data for the impact strength 31, the impact type 32, the quantified damage 33 and the cargo loss 34 to the digital system 1. Of course, other tools providing data for the cargo and logistics characteristics can be used as a data source as well. The measuring entities or data tools can for example be connected to the digital system 1 by the data transmission network 70.

Further, data for parameter values may detected and transmitted by tracking devices 80 like RFID chips, telematic devices or GPS sensors installed at the cargo 10 for capturing at least partially the cargo and logistics parameters 11 and 42. For example, the tracking devices 80 collect data about the geo location of the cargo, the orientation of the cargo or the velocity of the cargo. The data can be transmitted via the data transmission network 70.

Each of the risk factors represents at least one of the parameters or parameter values quantifying the negative impact 30. As such the risk factors indicate the probability of an occurrence of a negative impact 30 defined by the impact characteristics as explained above. The risk factors are for example statistically derived from a data set of historical measurements of the impact characteristics. For example, the risk factors are determined by (1) generating a measurement series of parameter values of an impact characteristics of an impact event 30, i.e., of the impact strength 31, the impact type 32 and/or the quantified damage 33, for various locations and/or situations, and (2) statistically determining the likelihood for the impact event described by the characteristics to happen for the locations or situations for the measured parameter. Consequently, there may be more than one risk factor for each of the impact characteristics. For example, there is a series of impact strength risk factors 5231 comprising intensity risk factors 52311, duration risk factors 52312, and frequency risk factors 52313. Another example are risk factors 52321 for a natural catastrophe 321 event e.g., in form of storm impact risk factors 523211 or flood impact risk factors 523212. In the same way risk factors for other impact characteristics may be generated for the measured parameter values for the impact characteristics as there are for example labor disruption 322, regulatory discontinuation 323, etc. and/or downtime 331, repair costs 332, delay times 333, rerouting costs 334, etc. and any other measured impact parameters.

The risk factors 52 may be provided by a data tool as mentioned above or the risk factors 52 may for example be generated by a risk modelling structure 26 that may be part of the processing unit 20 or be associated to the risk factor database 50. The risk modelling structure 26 could also be a computer application implemented in the processing unit 20. The risk modelling structure 26 may also be part of the data tool. The risk modelling structure 26 can generate a risk factor for a measurable cargo logistics parameter based on the measured parameter values of the impact strength 31 and/or impact type 32, and/or a measured quantified damage 33. Advantageously, all available risk factors 52 for the various impact characteristics can be stored in the risk factor database 50 or for example can be hosted in a cloud storage space and provided via the data transmission network 70.

As mentioned above, the allocation structure 22 assigns at least one a risk factor 52 to at least one of the measurable cargo logistics parameter 11 of a set 13 of measurable cargo logistics parameters. Advantageously several measurable cargo logistics parameters 11 receive a corresponding risk factor 52, and ideally there is a risk factor 52 available for all of the measurable cargo logistics parameters 11 of a set 13 of measurable cargo logistics parameters, which risk factors 52 establish a set of risk factors 51. The aggregating structure 25 is configured to automatically generate the aggregated risk measure 60 as a risk summary factor based on the available risk factors allocated to the set 13 of measurable cargo logistics parameters 11. The aggregating structure 25 may comprise an algorithm to generate a mean, maximum, average or a summed up aggregated risk value. Weighting factors for the risk factors may be used for example to consider risk priorities. The aggregated risk measure provides comparable cargo logistics services risk information that can easily and quickly be accessed and provides added value to the cargo logistics services package.

In the variant of the digital system 1 illustrated in FIG. 2 the processing unit 20 comprises an optimization structure 28 for optimizing the set 13 of measurable cargo logistics parameters for a cargo logistics services package to minimize the probability of the occurrence of a negative impact 30 for the selected cargo logistics parameters 11 of the cargo logistics service package. For example, the optimization structure 28 receives cargo characteristics and/or logistics characteristics selected by the logistics provider for a cargo logistics services package from the logistics input signal 400, wherein the cargo characteristics and/or logistics characteristics comprise alternatives that fulfill requirements of the services package. Further, the optimization structure 28 receives a set of risk factors 51 for one or more of the cargo and/or logistics characteristics from the risk factor database 50 for the characteristics alternatives. The optimization structure 28 e.g. selects the cargo logistics parameters 11 comprising the lowest risk factors 52 for each cargo and/or logistics characteristics and identifies the alternatives of the cargo logistics services parameters 11 associated with the lowest risk factors 52. It combines these lowest risk cargo logistics parameters to define the set of measurable cargo logistics parameters having the lowest risk aggregated risk measure 60 for the services package. Thus, the optimization structure finds the best available cargo parameters 11 and the best available logistics parameters 42 to create logistics services package that safely and reliably delivers the cargo 10 from A to B. The optimization structure 28 can for example be configured as a discrete or continuous optimization algorithm. The optimized set 13 of the measurable cargo logistics parameters 11 can be provided the extended output signal 610 to the logistics procurement platform 40 and serve as the basis for optimized insurance services.

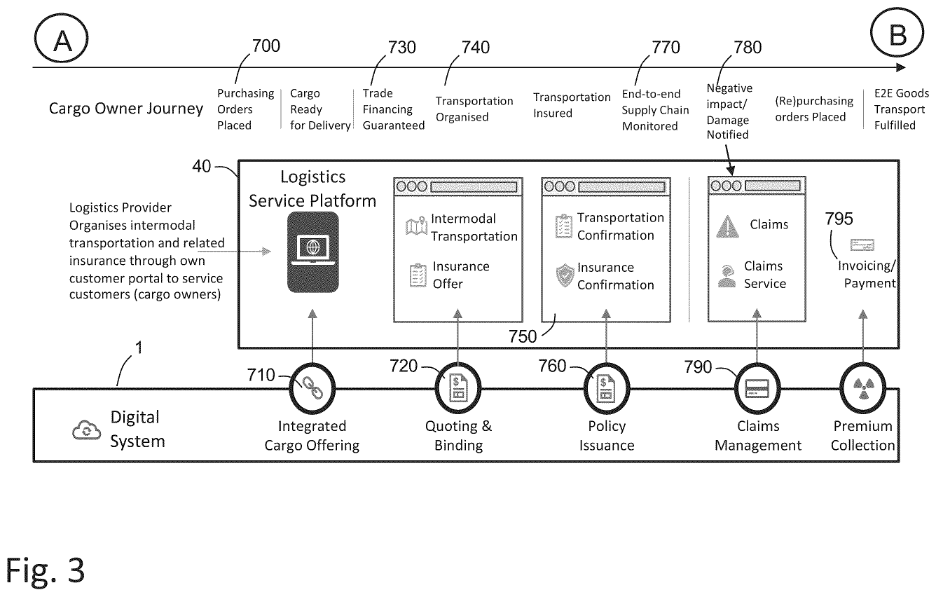

FIG. 3 illustrated a journey of a cargo owner shipping cargo from departure point A to destination point B, wherein a logistics provider uses a logistics procurement platform 40 and an implemented digital system 1 for applying the method for allocating and/or predicting risk measures for an occurrence of an impact event on cargo logistics services according to the invention. The logistic provider organizes intermodal transportation and related insurance through the logistics procurement platform 40 and the digital system 1. When the cargo owner places a purchasing order 700, the logistics provider gathers information about the requested logistics services and measurable cargo logistics parameters from the cargo owner and the logistics procurement platform 40. While the cargo gets ready for delivery the logistics provider provides an integrated offering 710 including a cargo logistics services package and an insurance offer to the cargo owner. The cargo logistics services package defines a set 13 of measurable cargo logistics parameters 11, which are provided to the digital system 1. The allocation structure 22 of the digital system 1 assigns a set of risk factors 51, received from the risk factor database 50, which set of risk factors 51 corresponds to the set 13 of measurable cargo logistics parameters 11. The aggregation structure 25 generates the aggregated risk measure 60, which serves as the basis for the insurance offer for the cargo logistics services package. In a next step trade financing 730 is guaranteed and transportation 740 is organized. Then the integrated offering 710 includes a quoting and binding step. In a confirmation step 750 the insurance policy 760 is issued and the transportation is confirmed. During the cargo logistics services the cargo is subject to end-to-end monitoring 770.

In case a negative impact on the cargo occurs a negative impact notification 780 is sent to the logistics procurement platform 40. The logistics procurement platform 40 registers claims connected to the negative impact and provides the claims for the digital system 1, which processes the claims in a claims management step 790 in a claims processing module 29 of the processing unit 20 or transmits claims information data to an external claims management application. Any type of invoicing 795 is processed by the logistics procurement platform 40 which includes premium collection for the insurance that is based on the aggregated risk measure 60 provided by the digital system 1 to assess the risk of an occurrence of an impact event causing a negative impact on the cargo logistics services package or the cargo.

In summary, the purchasing process for the cargo logistics services is simple and transparent, and is easily realized as an online service, which allows for checking availability checking and scheduling of the services. The digital quoting and booking step 720 can be done in real-time. The quoting of policy services and the issuance of the insurance policy 760 can happen immediately while invoicing and premium collection 795 is integrated in the process. Over all the effort for providing insurance quoting, issuance and premium collection is greatly reduced. The insurance service based on the aggregated risk measure 60 is customized to the needs of the cargo owner and the logistics provider, which reduces the risk of under-coverage and unnecessary high premiums. The digital system 1 and the associated method according to the invention simplify the all-in-one cargo logistics services handling and allow for accurate risk measuring of the cargo logistics services.

### LIST OF REFERENCE SIGNS

A Departure point
B Destination point
1 Digital system
2 Cargo owner
3 Logistics provider
10 Cargo
   11 Measurable cargo logistics parameters
   12 Cargo parameters
      121 Cargo weight
      122 Cargo size
      123 Cargo fragility
      124 Cargo value
   13 Set of measurable cargo logistics parameters
20 Processing unit
   21 Data interface to logistics procurement platform
   22 Allocation structure
   23 Data interface to risk factors database
   24 Signal generator
   25 Aggregating structure
   26, 26′ Risk modelling structure
   27 Database
   28 Optimization structure
30 Negative impact
   31 Impact strength
      311 Impact intensity
      312 Impact duration
      313 Impact frequency
   32 Impact type
      321 Natural catastrophe
      322 Labor disruption
      323 Regulatory discontinuation
   33 Quantified damage
      331 Down time
      332 Repair costs
      333 Delay time
      334 Rerouting costs
   34 Loss of cargo
40 Logistics procurement platform
   41 Cargo logistics services database
   42 Logistics parameters
      421 Cargo packaging design
         4211 Packaging material
         4212 Packaging thickness
         4213 Packaging quality
      422 Departure location characteristics
         4221 Geographical location
         4222 Infrastructure connectivity
         4223 Traffic volume
      423 Destination characteristics
      424 Transportation channel characteristics
         4241 Length of route
         4242 Number of transits
         4243 Expected weather conditions
         4244 Infrastructure conditions
      425 Transportation means
         4251 Transportation means type
         4252 Fuel efficiency
         4253 Age
      426 Logistics formalities
         4261 Type of regulatory process
         4262 Number of regulatory processes
         4263 Average processing time
   43 Air transportation route
   44 Sea transportation route
   45 Land transportation route
50 Risk factor database
51 Set of risk factors
52 Risk factor
   5231 Impact strength risk factors
      52311 Intensity risk factor
      52312 Duration risk factor
      52313 Frequency risk factor
60 Aggregated risk measure
70 Data transmission network
   71 Cellular mobile network
   72 Satellite transmission line
100 Logistics input signal
500 Risk factor input signal
600 Output signal
   610 Extended output signal
700 Purchasing order
   710 Integrated offering
   720 Quoting & binding step
   730 Trade financing guaranteed
   740 Transportation organized
   750 Confirmation step
   760 Insurance policy
   770 End-to-end monitoring
   780 Negative impact notification
   790 Claims management step
   795 Invoicing

1. A method for a digital system for predicting and measuring risk measures for an occurrence of an impact event impacting physical loss or damage on cargo or cargo logistics services having an impact with a measurable impact strength related to an impact type on the cargo or the cargo logistics services, the impact strength being quantified by measuring an impact severity or intensity and an impact duration and/or an impact frequency, the method comprising:
capturing sets of measurable cargo logistics parameters as logistics input signals from a cargo logistics services database via a data interface and transmitting the sets of measurable cargo logistics parameters to an allocation structure of a processor, each set of measurable cargo logistics parameters at least comprising parameters defining the cargo or parameters or defining the logistics services, the set of measurable cargo logistics parameters at least comprises cargo parameter values capturing cargo characteristics including cargo weight and/or cargo size and/or cargo fragility and/or cargo value, and logistics parameter values capturing logistics characteristics including cargo packaging design and/or departure location characteristics and/or destination location characteristics and/or transportation channel characteristics and/or transportation means, wherein the cargo and logistics parameters are at least partially detected and transmitted by tracking devices comprising Radio Frequency_Identification (RFID) chips or telematic devices or Global Position System (GPS) sensors installed at the cargo, the tracking devices measuring parameter values for geo location of the cargo, the orientation of the cargo or the velocity of the cargo and transmitting them via a data transmission network to the cargo logistics services database,
generating at least one risk factor indicating a measured impact probability for the cargo or the cargo logistics services by a risk modelling structure of the processor based on at least the measured parameter values of the impact strength and/or impact types and/or measured quantified damages and provided for the allocation structure of the processor, each of the risk factors at least corresponds to a measured impact strength or impact type of a negative impact on the cargo or the cargo logistics services, or a quantified damage at the cargo or on the cargo logistics services resulting from the impact, and
automatically generating an aggregated risk measure for the cargo or cargo logistics services by an aggregating structure of the processor based on the at least one risk factors allocated to measurable cargo logistics parameters of the set of measurable cargo logistics parameters, and is provided as output signal by a signal generator to predict an occurrence of a measurable negative impact on the cargo and/or the cargo logistics services.

2. The method according to claim 1, wherein the aggregated risk measure is assigned to the set of measurable cargo logistics parameters by the allocation structure and provided as extended output signal to the cargo logistics services database by the signal generator via a data interface.

3. The method according to claim 1, wherein at least one risk factor is based on measurable risk parameters indicating a damage in form of delay, damaging and/or loss of cargo, and/or in form of damaging of goods caused by the cargo logistics services.

4. The method according to claim 1, wherein at least one risk factor is based on measurable risk parameter values capturing a time of delay, a quantified damaging extend and/or loss of the cargo, and/or a quantified damaging extend of goods caused by the cargo logistics services.

5. The method according to claim 1, wherein a risk factor for an associated cargo logistics parameter is established by measuring the physical impact strength or impact type of impact events on the cargo and/or the cargo logistics services affected by the impact event, measuring the impact strength on the cargo or the cargo logistics services, measuring a damage of the cargo and/or the cargo logistics services caused by the impact event, and/or quantifying a probability of impact occurrence.

6. The method according to claim 1, wherein cargo logistics services include cargo handling, packaging, transportation, tracking, delivery and/or insuring, and/or logistics quoting, booking, scheduling, alerting, controlling and/or processing cargo formalities.

7. The method according to claim 1, wherein the aggregated risk measure is determined based on historical measures of risk parameter values for one or more cargo logistics parameters defining the cargo logistic services, wherein the output signal is indicative of the aggregated risk measure for the cargo logistic services in respect to the set of measured values for the cargo logistics parameters.

8. The method according to claim 1, wherein the aggregated risk measure is generated by the aggregating structure and allocated to the set of measurable cargo logistics parameters, the aggregated risk measure providing an aggregated impact probability measure value for the cargo logistics services to be involved in one or more impact events having a negative impact with a measurable impact strength and/or impact type.

9. The method according to claim 1, wherein the processor and/or the risk factor database include a damage or risk modelling structure generating a risk factor for a measurable cargo logistics parameter based on a measured impact strength and/or impact type, and/or a measured quantified damage.

10. The method according to claim 1, wherein the allocation structure assigns a risk factor to a measurable cargo logistics parameter by:
receiving a measurable cargo logistics services parameter defining the cargo logistics services or the cargo from the cargo logistics services database via the logistics input signal,
selecting at least one risk factor provided by the risk factor database via the risk input signal for an at least similar cargo logistics parameter indicating a damage probability measure based on past measured damages caused by past measured impact events related to the cargo logistics parameter and/or generated by a risk modelling structure for a measurable impact event, and
allocating the at least one risk factor to the measured cargo logistics services parameter defining the cargo logistics services.

11. The method according to claim 1, wherein an aggregated loss risk measure indicating a loss of the cargo by the cargo logistics services is generated based on the risk factors associated to the measured cargo logistics services parameter by the aggregating structure.

12. The method according to claim 1, wherein an optimization structure of the processor optimizes the set of measurable cargo logistics parameters for a cargo logistics service to minimize the probability of the occurrence of an impact event on the cargo logistic service indicated by the aggregated risk measure.

13. The method according to claim 1, wherein an optimization structure of the processor receives cargo logistics services characteristics from the logistics input signal and a set of risk factors for one or more of the cargo logistics services characteristics from the risk factor database, wherein the optimization structure selects the cargo logistics parameter comprising the lowest risk factor for each cargo logistics services characteristic, and combines the lowest risk cargo logistics parameters to define the set of measurable cargo logistics parameters.

14. The method according to claim 13, wherein the lowest risk factor is defined by a lowest physical impact strength of impact events on the cargo and/or the cargo logistics services affected by the impact event, a lowest impact strength on the cargo or the cargo logistics services, a lowest damage of the cargo and/or the cargo logistics services caused by the impact event, and/or a lowest probability of impact occurrence.

15. The method according to claim 1, wherein the aggregation structure and/or the optimization structure may be combined with an artificial intelligence structure comprising a machine learning algorithm.

16. A digital system for predicting and measuring risk measures for an occurrence of an impact event on cargo logistics services causing a negative impact with a measurable impact strength related to an impact type on the cargo or the cargo logistics services, the impact strength being quantified by measuring an impact severity or intensity and an impact duration and/or an impact frequency, the digital system comprising:
a processor; and
at least one data interface associated with accessing data to a cargo logistics services database for capturing sets of measurable cargo logistics parameters as logistics input signals from the cargo logistics services database,
wherein sets of measurable cargo logistics parameters are transmitted to an allocation structure of the processor, each set of measurable cargo logistics parameters at least comprising parameters defining the cargo or parameters defining the cargo logistics services, the set of measurable cargo logistics parameters at least comprises cargo parameter values capturing cargo characteristics including cargo weight and/or cargo size and/or cargo fragility and/or cargo value, and logistics parameter values capturing logistics characteristics including cargo packaging design and/or departure location characteristics and/or destination location characteristics and/or transportation channel characteristics and/or transportation means, wherein the cargo and logistics parameters are at least partially detected and transmitted by tracking devices comprising Radio Frequency Identification (RFID) chips or telematic devices or Global Position System (GPS) sensors installed at the cargo, the tracking devices measuring parameter values for geo location of the cargo, the orientation of the cargo or the velocity of the cargo and transmitting them via a data transmission network to the cargo logistics services database,
wherein the processor comprises a risk modelling structure for generating at least one risk factor indicating a measured impact probability for the cargo or the cargo logistics services and for providing the at least one risk factor to the allocation structure of the processor, each of the risk factors at least corresponds to a measured impact strength or impact type of a negative impact on the cargo or the cargo logistics services, or a quantified damage at the cargo or on the cargo logistics services resulting from the impact, wherein at least one measurable cargo logistics parameter of a set of measurable cargo logistics parameters is assigned a risk factor by the allocation structure that corresponds to a measured value of the measurable cargo logistics parameters, and
wherein the digital system further comprises a signal generator and an aggregating structure for automatically generating an aggregated risk measure for the cargo and the cargo logistics services based on the risk factors allocated to measurable cargo logistics parameters of the set of measurable cargo logistics parameters, wherein the aggregated risk measure is provided as output signal by the signal generator to predict an occurrence of a measurable negative impact on the cargo and/or the cargo logistics services.

17. The digital system according to claim 16, wherein the cargo logistics services database and/or the risk factor database comprise a persistent data storage storing data representing the measurable cargo logistics services parameters and/or representing the risk factors.
